(19) United States
(12) Patent Application Publication
(10) Pub. No.: US 2011/0261663 A1
(43) Pub. Date: Oct. 27, 2011

(54) INTEGRATED CIRCUIT AND OPTICAL DISC APPARATUS

(75) Inventors: Shinichi YAMADA, Osaka (JP); Kazuhiko Miyazaki, Kyoto (JP); Masato Asano, Osaka (JP)

(73) Assignee: PANASONIC CORPORATION, Osaka (JP)

(21) Appl. No.: 13/175,258

(22) Filed: Jul. 1, 2011

Related U.S. Application Data
(63) Continuation of application No. PCT/JP2010/006499, filed on Nov. 4, 2010.

(30) Foreign Application Priority Data
Dec. 7, 2009 (JP) 2009-277318

(51) Int. Cl. G11B 7/09

(52) U.S. Cl. 369/44.35; 369/44.11; G9B/7.062

(57) ABSTRACT

An integrated circuit includes a focus control section configured to perform focus control to generate a drive signal for the focus direction displacement section based on a focus error signal, a focus control error determination section configured to determine whether there is a focus control error or not, and a memory section configured to store error-time control signals which are used when there is a focus control error and correspond to a plurality of rotation angles. The focus control section stops the focus control and generates the drive signal for the focus direction displacement section, according to a rotation angle, based on the error-time control signals stored in the memory section at a radial position where it is determined by the focus control error determination section that there is a focus control error.

This is a continuation of PCT International Application PCT/JP2010/006499 filed on Nov. 4, 2010, which claims priority to Japanese Patent Application No. 2009-277318 filed on Dec. 7, 2009. The disclosures of these applications including the specifications, the drawings, and the claims are hereby incorporated by reference in their entirety.

### BACKGROUND

The present disclosure relates to an optical disc apparatus which irradiates an optical disc including an optical discoloration layer which is discolored by heat or light with laser light to draw a visible image thereon, and an integrated circuit provided in the optical disc apparatus.

Conventionally, techniques in which a data recording layer of a recordable optical disc is irradiated with laser light to change visible light characteristics of the data recording layer, thereby drawing an image such as a picture and characters have been known (see, for example, Japanese Patent Publication No. 2001-283470). Also, techniques in which a discoloration layer is formed in a label surface of an optical disc, and the coloration layer is irradiated with laser light from the label surface side of the optical disc to change visible light characteristics of the discoloration layer, thereby drawing an image such as a picture and characters (see, for example, Japanese Patent Publication No. 2002-203321) have been known.

An optical disc apparatus described in Japanese Patent Publication No. 2006-085849 is configured in the following manner, considering the case where it is difficult to attain control of focus on a data recording layer and a discoloration layer. That is, in this optical disc apparatus, in a state where focus control is not performed, an object lens is oscillated in an optical axis direction thereof by applying an oscillation signal to a focus actuator to cause a focus of an optical beam to repeatedly pass through a discoloration layer which is a target on which an image is drawn, thereby changing visible light characteristics. Also, in the optical disc apparatus of Japanese Patent Publication No. 2006-085849, a surface runout following signal generation device for measuring an amount by which a disc surface is displaced in an optical axis direction of laser light at a laser light irradiation position in the optical disc using an optical method and a mechanical method, etc. is provided. The surface runout following signal generation device applies a surface runout following signal to the focus actuator according to the above-described oscillation signal to roughly follow a surface runout of an optical disc.

An optical disc apparatus described in Japanese Patent Publication No. 2007-179633 draws an image while an object lens is oscillated in a radial direction of an optical disc at a predetermined setting frequency by a tracking direction displacement section (tracking actuator) in a state where tracking control is not performed. Thus, a scan interval of laser light per rotation of an optical disc is filled, so that an image without any blank regions can be obtained. Moreover, the setting frequency is set to be a frequency other than an inherent resonance frequency of the tracking direction displacement section.

### SUMMARY

However, according to Japanese Patent Publication No. 2006-085849, the surface runout following signal generation device is provided, and therefore, increase in size of the optical disc apparatus and in cost is caused.

In view of the above-described points, it is an object of the present disclosure to reduce the size of optical disc apparatuses and the cost.

In Japanese Patent Publication No. 2007-179633, there might be cases where the tracking direction displacement section is heated by a drive current and thus damaged. In particular, this problem is remarkably caused when an image is drawn on an entire label surface. Also, when the heat resistance of each of an optical head and the tracking direction displacement section is increased in order to prevent or reduce such damage, the cost of the optical head and the size of the optical disc apparatus are increased.

In view of the above-described points, it is another object of the present disclosure to prevent or reduce damage due to heat generation in the optical head and the tracking direction displacement section without causing increase in cost of the optical head and size of the optical disc apparatus.

To solve the above-described problems, according to one embodiment, an integrated circuit which is provided in an optical disc apparatus for drawing a visible image on an optical disc including a discoloration layer which is discolored by heat or light, the optical disc apparatus including a focusing section configured to focus laser light to irradiate the discoloration layer of the optical disc with the laser light, and a focus direction displacement section configured to displace the focusing section in a perpendicular direction to the discoloration layer of the optical disc by an amount corresponding to a drive signal, and being configured so that, each time the optical disc is rotated a predetermined number of times with the discoloration layer irradiated with the laser light, a laser light irradiation position which is irradiated with the laser light is moved in a radial direction of the optical disc by a predetermined moving amount to draw a visible image, includes a focus control section configured to perform focus control to generate a drive signal for the focus direction displacement section based on a focus error signal, a focus control error determination section configured to determine whether there is a focus control error or not, and a memory section configured to store error-time control signals which are used when there is a focus control error and correspond to a plurality of rotation angles, and the focus control section stops the focus control and generates the drive signal for the focus direction displacement section based on the error-time control signals stored in the memory section at a radial position where it is determined by the focus control error determination section that there is a focus control error.

According to this embodiment, the focus direction displacement section is driven by the drive signal based on the error-time control signal stored in the memory section at the radial position where it is determined that there is a focus control error. Therefore, a proper error-time control signal for positioning a focus of laser light at the discoloration layer of the optical disc is stored in the memory section. Thus, without a surface runout following signal generation device provided, image drawing can be performed while causing the focus position of the laser light to follow the discoloration layer of the optical disc.

According to another embodiment, an integrated circuit which is provided in an optical disc apparatus for irradiating an optical disc including a discoloration layer which is discolored by heat or light with laser light to draw a visible image thereon, the optical disc apparatus including a focusing section configured to focus the laser light to irradiate the discoloration layer with the laser light, and a tracking direction displacement section configured to displace the focusing section in a radial direction of the optical disc according to a drive current at a setting frequency and having a second-order transfer characteristic, includes a setting section configured to set the setting frequency to be a frequency within a range with which a gain of the tracking direction displacement section is higher than a DC gain while the visible image is drawn.

According to this embodiment, the gain of the tracking direction displacement section is higher than the DC gain. Thus, the tracking direction displacement section can displace the focusing section with a small drive current. Therefore, heat generation in the tracking direction displacement section can be reduced while the drive current is reduced, so that damage due to heat generation in the tracking direction displacement section can be prevented without causing a problem of increase in cost for an optical head and in size of the optical disc apparatus in increasing heat resistance of the tracking direction displacement section.

According to the present disclosure, without a surface runout following signal generation device provided, image drawing may be performed while causing the focus position of the laser light to follow the discoloration layer of the optical disc.

According to the present disclosure, damage due to heat generation in the tracking direction displacement section can be prevented without causing a problem of increase in cost for an optical head and in size of the optical disc apparatus in increasing heat resistance of the tracking direction displacement section.

### BRIEF DESCRIPTION OF THE DRAWINGS

FIG. 1 is a block diagram illustrating a configuration of an optical disc apparatus according to a first embodiment.

FIG. 2 is a partial cross-sectional view illustrating an optical disc according to the first embodiment.

FIG. 3 is a flowchart showing the operation of a microcomputer according to the first embodiment.

FIG. 4 is a block diagram illustrating a configuration of a memory circuit according to the first embodiment.

FIG. 5 is a timing chart showing the operation of the optical disc apparatus of the first embodiment.

FIG. 6 is a flowchart showing the operation of the microcomputer of the first embodiment.

FIG. 7 is a diagram illustrating an amount of reflected light when an extraneous material exists on an optical disc.

FIG. 8 is a block diagram illustrating a configuration of an error determination circuit according to a variation of the first embodiment.

FIG. 9 is a block diagram illustrating a configuration of an optical disc apparatus according to a second embodiment.

FIG. 10 is a bode plot showing gain characteristics of a tracking actuator according to the second embodiment.

FIG. 11 is a flowchart showing the operation of the optical disc apparatus of the second embodiment.

FIG. 12 is a graph showing the relationship between a drive current of the tracking actuator according to the second embodiment and a lens displacement signal.

FIG. 13A is a timing chart showing a drive current of the tracking actuator according to a step signal output by a step signal generation circuit according to the second embodiment. FIG. 13B is a timing chart showing a lens displacement signal.

FIG. 14A is a timing chart showing a lens displacement signal when a spot of optical beam crosses a track. FIG. 14B is a timing chart showing a track crossing signal.

### DETAILED DESCRIPTION

Embodiments will be described with reference to the accompanying drawings below.

### First Embodiment

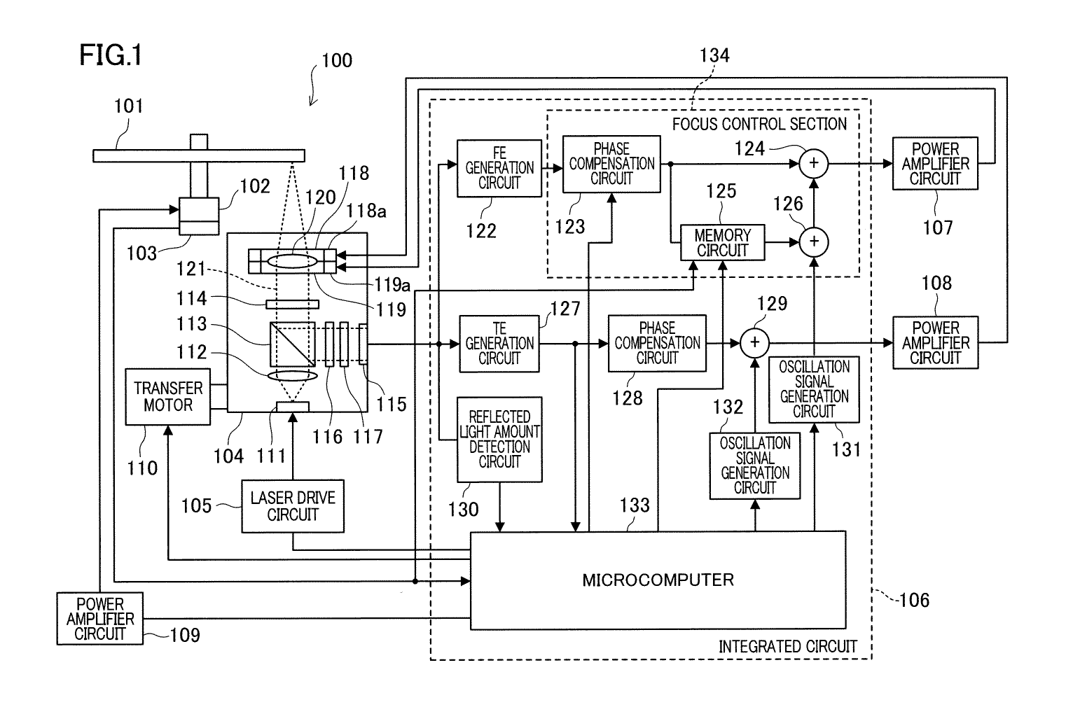

FIG. 1 illustrates an optical disc apparatus 100 according to a first embodiment.

The optical disc apparatus 100 performs recording/reproduction to/from an optical disc 101. The optical disc 101 includes, at a label surface side, a discoloration layer 201 (which will be described later) which is discolored by light, and is configured so that an image can be drawn on the label surface. Note that a discoloration layer which is discolored by heat may be used as the discoloration layer 201.

The optical disc apparatus 100 includes a disc motor 102, a FG generation circuit 103, an optical head 104, a laser drive circuit 105, an integrated circuit 106, power amplifier circuits 107-109, and a transfer motor 110.

The optical disc 101 is placed on the disc motor 102, and the disc motor 102 rotates the optical disc 101 at a predetermined rotation rate. In this embodiment, the optical disc 101 is placed on the disc motor 102 to be irradiated with laser light 121 from the label surface side.

The FG generation circuit 103 generates a FG signal at a frequency corresponding to the rotation rate of the disc motor 102, based on a counter electromotive voltage generated when the disc motor 102 rotates. The FG generation circuit 103 generates a FG signal of 6 pulses per rotation of the disc motor 102.

The optical head 104 includes a laser 111, a coupling lens 112, a polarized light beam splitter 113, a ¼ wavelength plate 114, an optical detector 115, a detection lens 116, a tube lens 117, a focus actuator (focus direction displacement section) 118, a tracking actuator 119, and an object lens (focusing section) 120.

The laser 111 generates laser light 121, and the generated laser light 121 is changed into parallel light by the coupling lens 112 and then passes through the polarized light beam splitter 113 and the 1/4 wavelength plate 114. The object lens 120 focuses the laser light 121 which has passed through the 1/4 wavelength plate 114 on the discoloration layer 201 at the label surface of the optical disc 101 so that the discoloration layer 201 is irradiated with the laser light 121.

Light reflected from the label surface of the optical disc 101 passes through the object lens 120, the ¼ wavelength plate 114, the polarized light beam splitter 113, the detection lens 116, and the tube lens 117, and enters the optical detector 115. The optical detector 115 detects incident reflected light.

Note that when data is recorded in a recording surface of the optical disc 101 (which is an opposite surface to the label surface), and when data in the recording surface is reproduced, the optical disc 101 is placed on the disc motor 102 to be irradiated with the laser light 121 from the recording surface side. In this case, similar to light reflected from the label surface, light reflected from the recording surface of the optical disc 101 passes through the object lens 120, the ¼ wavelength plate 114, the polarized light beam splitter 113, the detection lens 116, and the tube lens 117, and enters the optical detector 115.

The laser drive circuit 105 drives the laser 111. Laser power at the time of reproduction and laser power at the time of recording are set to the laser drive circuit 105 by a microcomputer 133, which will be described later.

The focus actuator 118 includes a focusing coil 118a and a permanent magnet (not shown). The object lens 120 is attached to a movable portion of the focus actuator 118. A current corresponding to a voltage output by the power amplifier circuit 107, which will be described later, flows through the focusing coil 118a of the focus actuator 118. The focusing coil 118a receives magnetic force from the permanent magnet, and thus, the object lens 120 moves in a perpendicular direction to the label surface and the recording surface of the optical disc 101 (e.g., the top-and-bottom direction in FIG. 1).

The tracking actuator 119 includes a tracking coil 119a and a permanent magnet (not shown). A current corresponding to a voltage output by the power amplifier circuit 108 flows through the tracking coil 119a of the tracking actuator 119. The tracking coil 119a receives magnetic force from the permanent magnet, and thus, the object lens 120 is displaced in the diameter direction of the optical disc 101 (e.g., the left-and-right direction in FIG. 1).

The integrated circuit 106 includes a focus error signal generation circuit (which will be hereinafter referred to as an FE generation circuit) 122, a phase compensation circuit 123, an adder circuit 124, a memory circuit 125, an adder circuit 126, a tracking error signal generation circuit (which will be hereinafter referred to as a TE generation circuit) 127, a phase compensation circuit 128, an adder circuit 129, a reflected light amount detection circuit 130, an oscillation signal generation circuit 131, an oscillation signal generation circuit 132, and a microcomputer (which will be hereinafter referred to as a micon) 133.

The FE generation circuit 122 generates a focus error signal (which will be hereinafter referred to as an FE signal) indicating a difference between a focus of the laser light 121 and the discoloration layer 201 of the optical disc 101, based on reflected light detected by the optical detector 115.

The phase compensation circuit 123 is a filter which advances the phase of the FE signal generated by the FE generation circuit 122 to output the FE signal, in order to stabilize a focus control system. The phase compensation circuit 123 outputs 0 while focus control is stopped.

The memory circuit 125 stores an error-time control signal which is used, instead of an output of the phase compensation circuit 123, when there is a focus control error, for each of a plurality of rotation angles of the optical disc 101.

The phase compensation circuit 123, the adder circuit 124, the memory circuit 125, and the adder circuit 126 form a focus control section 134. The focus control section 134 performs focus control to generate a drive signal for the focus actuator 118, based on the focus error signal generated by the FE generation circuit 122. The focus control is feedback control. A drive signal generated by the focus control drives the focus actuator 118 to displace the object lens 120 so that a focus of the laser light 121 is positioned on the discoloration layer 201 at all the time.

A track is formed in advance in an inner circumference area of the label surface of the optical disc 101. In the inner circumference area, control data for drawing an image is recorded. The TE generation circuit 127 generates a tracking error signal (which will be hereinafter referred to as a TE signal) indicating a difference between the track and a beam spot of the laser light 121, based on the control data recorded in the inner circumference area (control data area). In general, when a detection method called push-pull method is used, a TE signal is calculated based on a difference signal derived from outputs of a two-divided light detector which receives reflected light of the laser light 121 from the optical disc 101.

The phase compensation circuit 128 is a filter which advances the phase of the TE signal generated by the TE generation circuit 127 to output an obtained signal, in order to stabilize the tracking control system. The phase compensation circuit 128 outputs 0 while tracking control is stopped.

The reflected light amount detection circuit 130 detects the amount of reflected light detected by the optical detector 115 and outputs the detected amount of the reflected light to the micon 133.

The oscillation signal generation circuit 131 generates an oscillation signal. The oscillation signal is generated to displace the object lens 120 in a perpendicular direction to the recording surface of the optical disc 101 with predetermined cycle and amplitude.

The oscillation signal generation circuit 132 generates an oscillation signal, when an image is drawn on the label surface. The oscillation signal is generated so that a beam spot of the laser light 121 is displaced in the diameter direction on the discoloration layer 201 of the optical disc 101 with predetermined cycle and amplitude.

The power amplifier circuit 107 amplifies power output by the adder circuit 124 to supply a current to the focusing coil 118a of the focus actuator 118.

The power amplifier circuit 108 amplifies power output by the adder circuit 129 to supply a current to the tracking coil 119a of the tracking actuator 119. According to the TE signal, the object lens 120 is driven by the phase compensation circuit 128 and the power amplifier circuit 108, and a focus of the laser light 121 is controlled to be positioned on a track at all the time. Note that this tracking control system is also used when data is recorded in the recording surface of the optical disc 101 and when data in the recorded surface is reproduced.

The power amplifier circuit 109 amplifies a control signal of the disc motor 102 output by the micon 133 to output the amplified control signal to the disc motor 102.

The transfer motor 110 is, for example, a stepping motor, and moves the optical head 104 in the diameter direction of the optical disc 101. The transfer motor 110 is controlled by the micon 133.

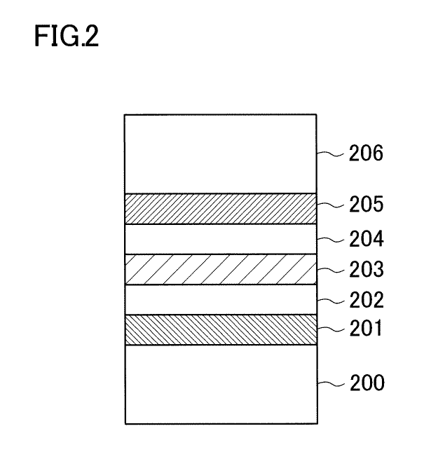

FIG. 2 illustrates a cross section of the optical disc 101. The optical disc 101 is a DVD-R disc. Note that, as the optical disc 101, an optical disc of some other type may be used.

A portion of the optical disc 101 located at the label surface side has a configuration in which the discoloration layer 201 and a reflection layer 202 are grown in this order on one surface of a first substrate 200 made of, for example, polycarbonate. A portion of the optical disc 101 located at the recording surface side has a configuration in which a pigment layer 205 and a reflection layer 204 are grown in this order on one surface of a second substrate 206. A bonding adhesion layer 203 for bonding the portion at the label surface side and the portion at the recording surface together is provided between the reflection layer 202 and the reflection layer 204. The thickness of the first substrate 200 and the second substrate 206 is about 0.6 mm. The thicknesses of the discoloration layer 201, the reflection layers 202 and 204, the bonding adhesion layer 203, and the pigment layer 205 are negligibly small, as compared to the thicknesses of the first substrate 200. Thus, the FE signal when the discoloration layer 201 is irradiated with light beam from the label surface side and the FE signal when the pigment layer 205 is irradiated with light beam from the recording surface side have substantially the same characteristics. That is, focus control when an image is drawn on the label surface can be performed in a similar manner to focus control when data is recorded in the recording surface.

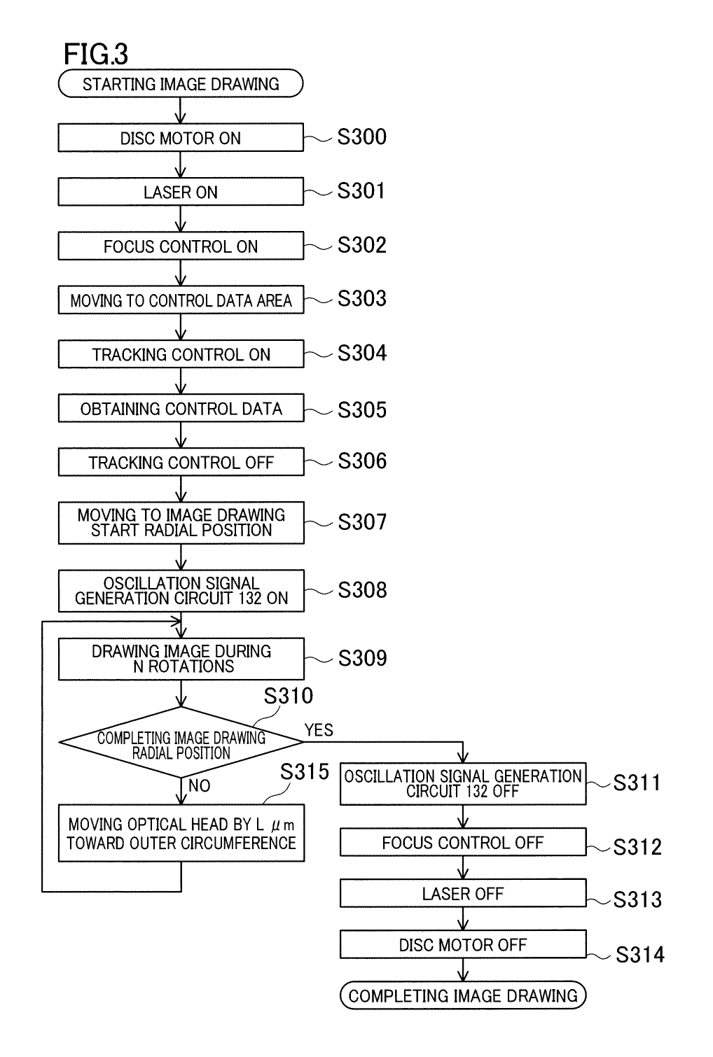

Next, the operation of the micon 133 in the optical disc apparatus 100 configured as described above will be described with reference to FIG. 3.

When a computer, etc. instructs the optical disc apparatus 100 to draw an image, the micon 133 outputs a signal for controlling the disc motor 102 to rotate the optical disc 101 at a predetermined rotation rate (S300). Next, the micon 133 controls the laser drive circuit 105 to cause the laser 111 to emit light with reproduction power (S301), and thus, focus control is activated (S302). Then, the micon 133 controls the transfer motor 110 to move the optical head 104, thereby moving a beam spot of the laser light 121 to a control data area (S303). Next, the micon 133 activates tracking control (S304), obtains control data (S305), and sets laser power at the time of image drawing, etc. for image drawing. Next, the micon 133 stops the tracking control operation (S306) and controls the transfer motor 110, thereby moving the beam spot of the laser light 121 to an image drawing start radial position (S307). Then, the oscillation signal generation circuit 132 is operated (S308).

According to the control of the micon 133, the optical disc apparatus 100 overwrites the same drawing data for a period in which the optical disc 101 is rotated n times (S309). When the optical disc 101 has been rotated n times, the micon 133 determines whether image drawing up to a drawing end radial position has been completed in S310. If the image drawing has been competed, the process proceeds to 5311, and if the image drawing has not been completed, the process proceeds to S315. In S315, the micon 133 moves the optical head 104 by L μm toward an outer circumference, and the process returns to S309. Then, in S311, the operation of the oscillation signal generation circuit 132 is stopped, and thereafter, focus control is stopped (S312), the laser 111 is turned off (S313), the disc motor 102 is turned off (S314), and image drawing is completed.

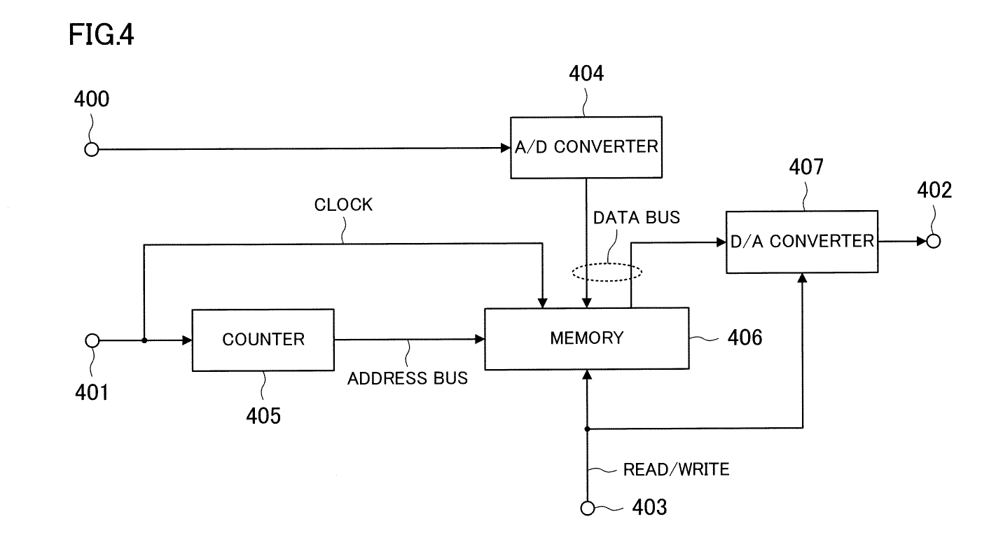

FIG. 4 illustrates a configuration of the memory circuit 125.

The memory circuit 125 includes terminals 400, 401, 402, and 403, an A/D converter 404, a counter 405, a memory 406, and a D/A converter 407.

The terminal 400 is coupled to the phase compensation circuit 123, the terminal 401 is coupled to the FG generation circuit 103, the terminal 402 is coupled to the adder circuit 126, and the terminal 403 is coupled to the micon 133.

The A/D converter 404 converts an output signal of the phase compensation circuit 123 to a digital value, and outputs the digital value to a data bus of the memory 406.

The counter 405 counts rising edges of an FG signal, and send a count value to an address bus of the memory 406. When the count value is 5, the counter 405 is reset to be 0 at the subsequent rising edge. Therefore, the value of the address bus is a value from 0 to 5.

In a state where a write mode is set by the micon 133, the memory 406 stores a value of the data bus at an address specified by the value of the address bus at a falling edge of the FG signal. On the other hand, in a state where a read mode is set by the micon 133, the memory 406 outputs a value stored at an address specified by the value of the address bus to the data bus at a falling edge of the FG signal.

The D/A converter 407 converts a value of the data bus to an analog value, and outputs the analog value. Note that the D/A converter 407 outputs a 0 level signal in a state where the write mode is set.

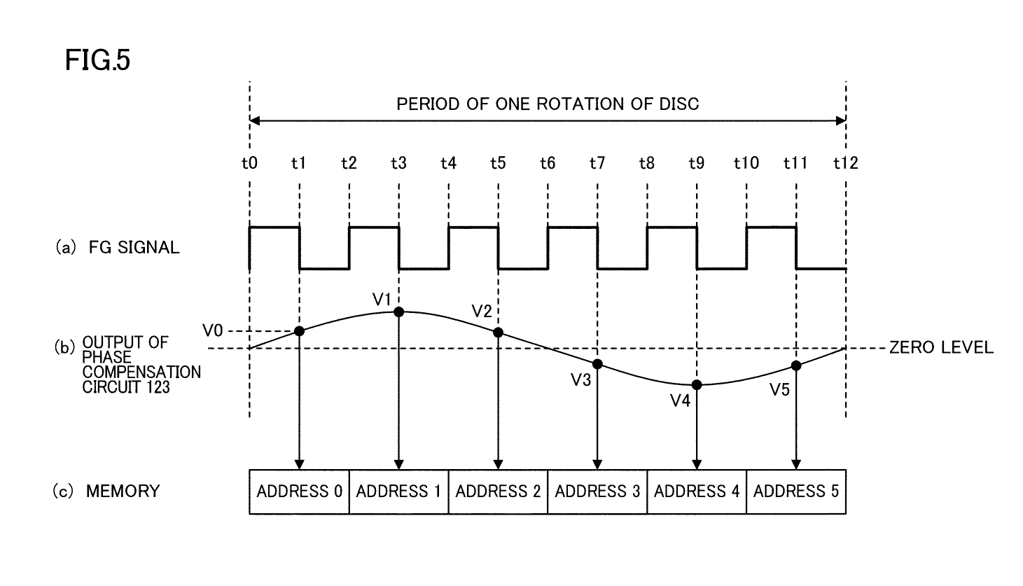

Next, the operation of the memory circuit 125 will be described with reference to FIG. 5. In FIG. 5, a waveform (a) shows an FG signal, a waveform (b) shows an input signal of the A/D converter 404, and (c) shows addresses in a memory respectively corresponding to timings.

First, an operation in the write mode will be described. The counter 405 counts rising edges of the waveform (a). Thus, the count value increases at t0, t2, t4, t6, t8, and t10. The count value is 5 at t10, and is reset to be 0 at t12. The memory 406 stores an output value of the A/D converter 404 at each falling edge of the waveform (a). At t1, the count value is 0, and therefore, V0 which is the level of the waveform (b) at t1 is stored at an address 0. At t3, the count value is 1, and therefore, V1 which is the level of the waveform (b) at t3 is stored, as an error-time control signal, at an address 1. Similarly, V2, V3, V4, and V5 which are the levels of the waveform (b) are stored as error-time control signals at t5, t7, t9, and t11.

In the read mode, an error-time control signal stored at an address corresponding to the count value of the counter 405 is called up. If the rotation angle of the optical disc 101 is the same, the amount of disc surface runout is substantially the same. Therefore, the address of the memory corresponds to the rotation angle of the optical disc 101, and the value of the error-time control signal corresponds to the surface runout amount at the rotation angle. When focus control is set off, and the error-time control signal stored in the memory circuit 125 is read out according to the count value of the counter 405 to drive the focus actuator 118, the focus of the laser light 121 is located substantially at the discoloration layer 201.

Note that the value of an oscillation signal generated by the oscillation signal generation circuit 131 is set so that displacement of the object lens 120 is equal to or larger than a defocus amount (a focus shift amount) generated when the focus actuator 118 is driven according to the value stored in the memory circuit 125 in a state where focus control is set off

Next, an operation performed when an extraneous material, etc. is attached onto the label surface and the laser light 121 is not properly reflected at the optical disc 101 will be described. When the extraneous material attached onto the label surface is large, a proper FE signal cannot be obtained for a long time period. Therefore, the defocus amount is increased, a distance between the discoloration layer 201 of the optical disc 101 and the focus position of the laser light 121 is out of a FE signal detectable range, and thus, focus control has to be set off once and then set on again. However, even when focus control is set on at the same radial position where the extraneous material is attached, the optical disc apparatus 100 returns to the same state again.

Then, when it is detected that the reflected light amount detected by the reflected light amount detection circuit 130 is lower than a predetermined level for a period equal to or longer than a predetermined time, the micon 133 sets focus control off, and puts the memory circuit 125 into the read mode to operate the oscillation signal generation circuit 131.

In a predetermined zone from the radial position where the focus control is set off, the focus actuator 118 is driven by an error-time control signal stored in the memory circuit 125, and an image is drawn in a state where focus control is set off by the micon 133. Therefore, the focus of the laser light 121 is positioned substantially on the discoloration layer 201 while an image is drawn in the predetermined zone. When the image drawing in the predetermined zone is completed, the micon 133 sets off the oscillation signal generation circuit 131, and puts the memory circuit 125 into the write mode to set on focus control again.

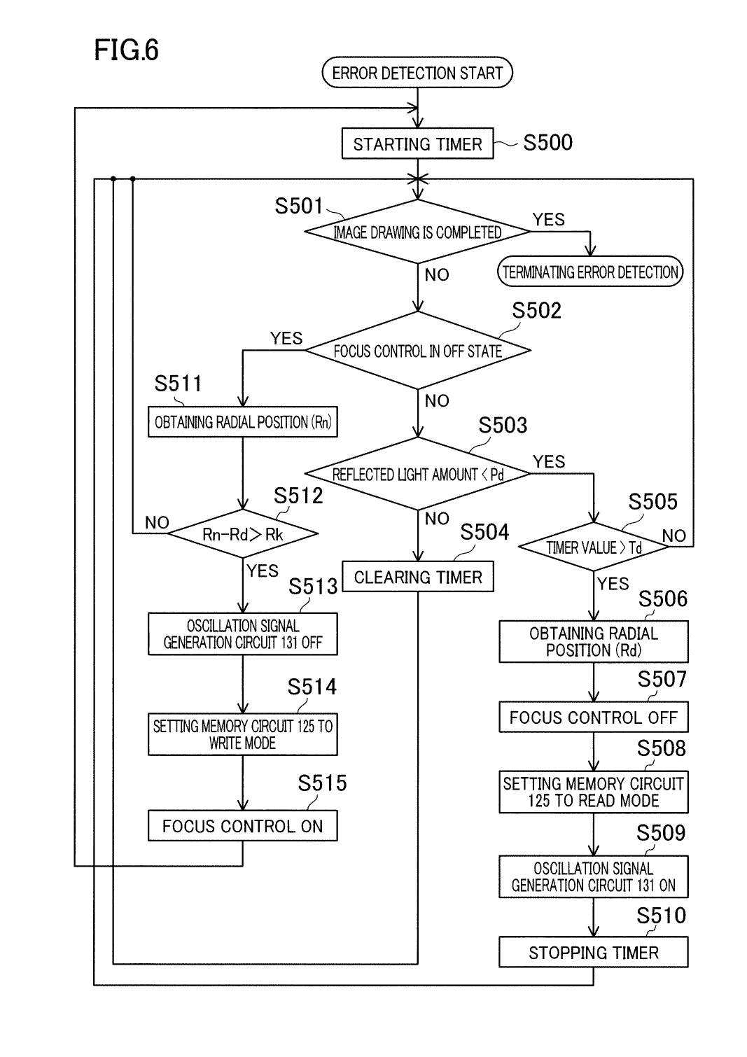

Next, the operation of the micon 133 will be described with reference to the flowchart of FIG. 6. Focus control error detection is performed in parallel to the image drawing operation.

The micon 133 starts a timer, when error detection is started (S500). Next, it is determined whether image drawing up to an image drawing end radial position is completed or not (S501). If image drawing is not completed, the process proceeds to S502. On the other hand, if image drawing is completed, error detection is terminated. In S502, it is determined whether focus control is set off by detecting an error. If focus control is in an on state, the process proceeds to S503. On the other hand, if focus control is in an off state, the process proceeds to S511. In S503, it is determined whether the reflected light amount is lower than a predetermined level Pd or not. If the reflected light amount is not lower than the predetermined level Pd, the timer is cleared in S504, and the process returns to S501.

When the reflected light amount is reduced due to an extraneous material being attached, etc., it is determined that the reflected light amount is lower than the predetermined level Pd in S503, and the process of S505 is performed. In S505, it is determined whether a timer value is larger than a reference Td or not. If the timer value is equal to or lower than the reference Td, the process returns to 5501 again. On the other hand, if the timer value is larger than the reference Td, the process proceeds to 5506. In S506, a radial position Rd of the optical head 104 at this time point is obtained. Then, focus control (feedback control) is set off (S507), the memory circuit 125 is set to be in the read mode (S508), and the oscillation signal generation circuit 131 is turned on (S509). Next, the timer is stopped (S510), and the process returns to S501 again.

In S502, if it is determined that focus control is in an off state, the radial position Rn of the optical head 104 at this point in time is obtained in S511, and in S512, it is determined whether or not an image has been drawn in the predetermined zone since focus control was set off. In expressions in FIG. 6, the predetermined zone is denoted by Rk. When an image has not been drawn in the predetermined zone, the process returns to S501. On the other hand, when an image has been drawn in the predetermined zone, the oscillation signal generation circuit 131 is turned off (S513), and the memory circuit 125 is set to be in the write mode (S514). Then, the focus control is set on again (S515), and the process returns to S500.

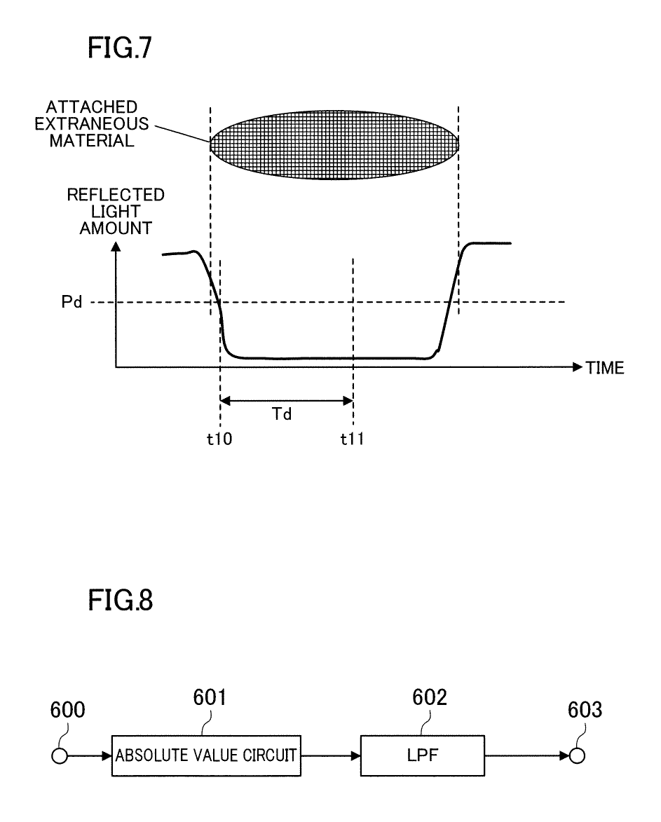

FIG. 7 illustrates change in the reflected light amount when an extraneous material is attached onto the optical disc 101.

In FIG. 7, the reflected light amount is reduced due to the extraneous material being attached and is smaller than Pd which is the reference level at t10. The timer starts at t10, and a focus control error is detected at t11 after a lapse of time Td.

According to this embodiment, the focus actuator 118 is driven by a drive signal based on an error-time control signal stored in the memory circuit 125 at a radial position where it is determined that there is a focus control error. Therefore, a proper error-time control signal for positioning a focus of laser light at the discoloration layer 201 of the optical disc 101 is stored in the memory circuit 125. Thus, without a surface runout following signal generation device provided, image drawing can be performed while causing the focus position of the laser light to follow the discoloration layer 201 of the optical disc 101.

Note that in a state where focus control is set off, the focus actuator 118 is driven by a value stored in the memory circuit 125, but the defocus amount increases, as compared to a state where focus control is set on. When the defocus amount increases, a drawn image might be faded. Thus, after S510 of FIG. 6, i.e., when an error-time control signal stored in the memory circuit 125 is used, laser power may be set higher as compared to the laser power when focus control is performed. Similarly, after S510 of FIG. 6, i.e., when an error-time control signal stored in the memory circuit 125 is used, the rotation number N in S309 of FIG. 3, i.e., the number of rewrites may be set larger as compared to the rotation number N (the number of rewrites) when focus control is performed. Furthermore, after S510 of FIG. 6, i.e., when an error-time control signal stored in the memory circuit 125 is used, the moving amount L (μm) of the optical head in S315 of FIG. 3 may be set smaller as compared to the moving amount L (μm) when focus control is performed. Fading of an image due to an increased defocus amount can be prevented by the above-described methods. When the above-described methods are employed, the setting value is reset to an initial value in S515 of FIG. 6.

In this embodiment, the FG generation circuit 103 outputs a FG signal of 6 pulses per rotation of a disc. However, the number of pulses per rotation is not limited to 6, and the number of pulses per rotation can be increased to improve accuracy. Instead of a FG signal, a signal generated by multiplying a FG signal may be input to the memory circuit 125.

In this embodiment, whether there is a focus control error or not is determined based on the reflected light amount. However, whether there is a focus control error or not may be determined based on whether an absolute value of a drive signal generated by focus control of the focus control section 134 is higher than a predetermined level. When the defocus amount increases due to an extraneous material being attached, a distance between the discoloration layer 201 of the optical disc 101 and the focus position of the laser light 121 is out of the FE signal detectable range, and focus control is not properly performed, the output value of the phase compensation circuit 123 increases in the positive direction or the negative direction.

For example, an error determination circuit of FIG. 8 may be provided in the optical disc apparatus 100. The error determination circuit of FIG. 8 includes a terminal 600, an absolute value circuit 601, a low-pass filter (LPF) 602, and a terminal 603. The terminal 600 is coupled to an output terminal of the phase compensation circuit 123, and the terminal 603 is coupled to the micon 133. The absolute value circuit 601 outputs an absolute value of an input signal. The LPF 602 removes high frequency noise components from the absolute value output by the absolute value circuit 601 to output an obtained signal. When the level of the output signal of the LPF 602 is larger than a predetermined level for a predetermined time period, the micon 133 determines that there is a focus control error.

### Second Embodiment

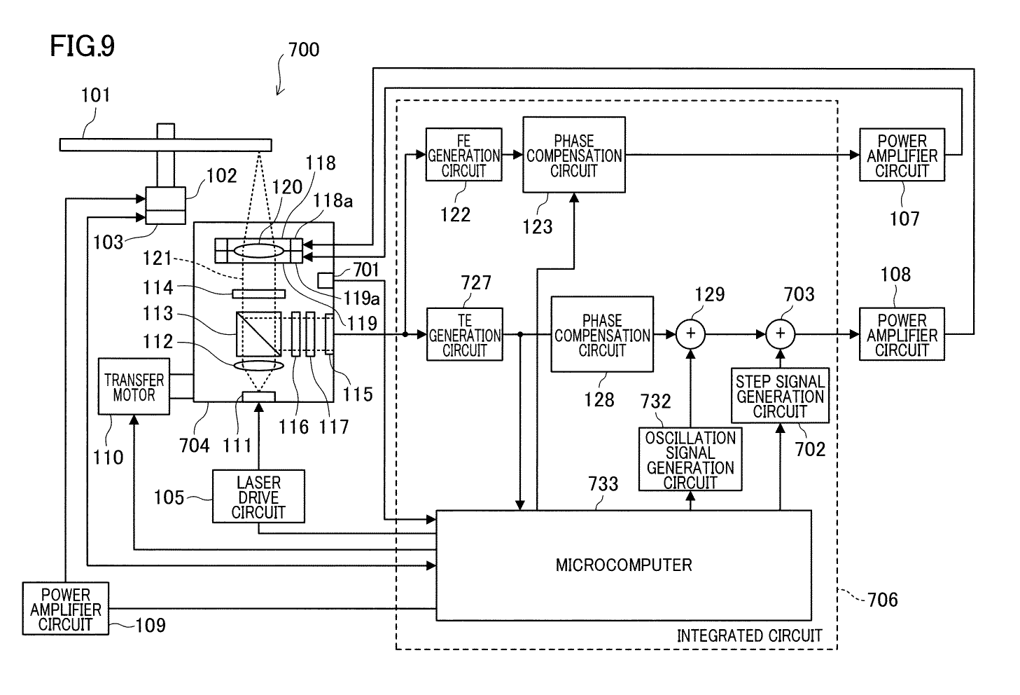

FIG. 9 illustrates an optical disc apparatus 700 according to a second embodiment.

Note that each member identified by the same reference character as that in the first embodiment performs the same operation as that in the first embodiment, and therefore, the description thereof will be omitted.

The optical disc apparatus 700 includes an optical head 704, instead of the optical head 104 of the first embodiment, and also includes an integrated circuit 706, instead of the integrated circuit 106 of the first embodiment.

The optical head 704 has a similar configuration to the configuration of the optical head 104 of the first embodiment and, in addition, includes a temperature sensor 701. The temperature sensor 701 is provided to be located near to a tracking coil 119a and detects the temperature of the tracking actuator 119.

The integrated circuit 706 includes a FE generation circuit 122, a phase compensation circuit 123, a TE generation circuit 727, a phase compensation circuit 128, an adder circuit 129, an oscillation signal generation circuit 732, a step signal generation circuit 702, an adder circuit 703, and a microcomputer (which will be hereinafter referred to as a micon) 733.

The oscillation signal generation circuit 732 generates a sine wave having a setting frequency and amplitude, which are set by the micon 733.

The step signal generation circuit 702 generates a step signal according to an instruction from the micon 733.

When an area of an inner circumference of a label surface in which a track is formed in advance is irradiated with laser light 121, the TE generation circuit 727 generates a TE signal indicating a difference between a track and a beam spot of the laser light 121. When an image drawing area in which a track is not formed is irradiated with the laser light 121, the TE generation circuit 727 generates a lens displacement signal indicating displacement of the object lens 120 from a neutral position.

When an image is drawn on the label surface, the micon 733 stops tracking control, and an output of the oscillation signal generation circuit 732 is sent to the power amplifier circuit 108 via the adder circuit 129. Thus, the beam spot of the laser light 121 is displaced in a radial direction on a discoloration layer 201 of an optical disc 101 with a predetermined setting frequency (a predetermined frequency) and a predetermined amplitude. While tracking control is stopped, an output of the phase compensation circuit 128 is 0. While an image is drawn on the label surface, the output of the step signal generation circuit 702 is 0.

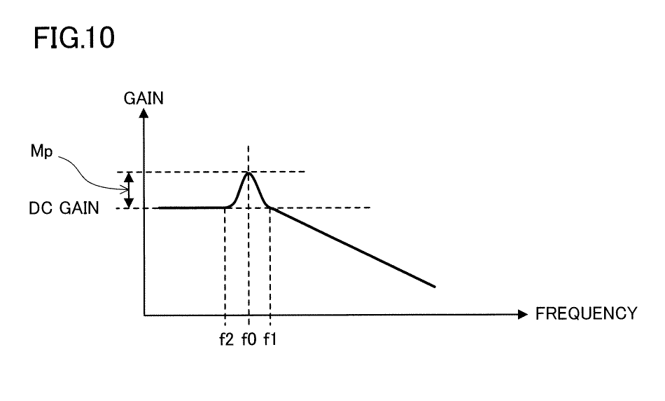

The tracking actuator 119 which receives a drive current as an input and outputs a displacement amount of the object lens 120 in the radial direction of the optical disc 101 has an oscillatory second-order transfer characteristic. FIG. 10 is a graph in which the displacement amount of the object lens 120 in the radial direction is plotted as the setting frequency is changed while the amplitude of the drive current of the tracking actuator 119 is kept constant. In FIG. 10, the horizontal axis indicates the setting frequency, and the vertical axis indicates the gain of the displacement amount of the object lens 120 driven by the tracking actuator 119. Note that the horizontal and vertical axes are both logarithmic axes. A frequency f0 is an inherent resonance frequency of the tracking actuator 119. The gain is the highest at the frequency f0, and then, decreases with a constant gradient slope at the frequency f1, which is slightly higher than ID, and at higher frequencies. The gain is constant at a frequency 12, which slightly lower than ID, and at lower frequencies. Each of the gains at the frequencies f1 and f2 is referred to as DC gain (direct current gain). When the object lens 120 is caused to oscillate in the radial direction of the optical disc 101 with a predetermined amplitude, the drive current can be reduced by causing the object lens 120 to oscillate at the frequency ID.

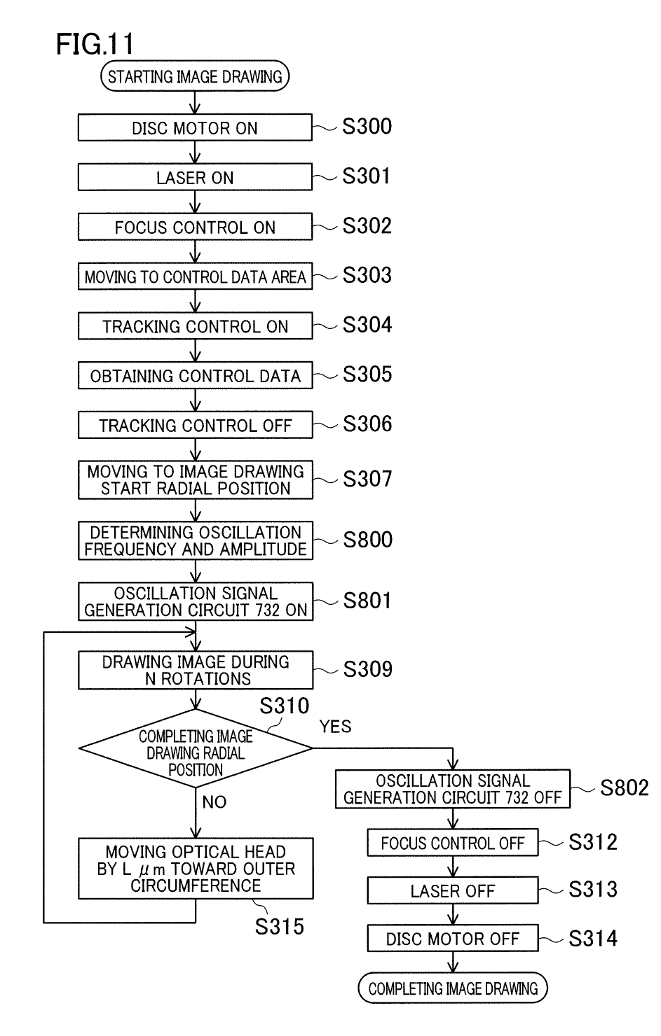

Next, the operation of the micon 733 in the optical disc apparatus 700 configured in the above-described manner will be described with reference to FIG. 11. Each step also shown in FIG. 3 of the first embodiment is identified by the same reference character, and the description thereof will be omitted.

The micon 733 determines a setting frequency fw and an amplitude Hw of the oscillation signal generation circuit 732 in an imaging drawing state in 5800. The setting frequency fw is the inherent resonance frequency f0 of the tracking actuator 119. The amplitude Hw is a value for displacing the object lens 120 by a predetermined amount, and is calculated based on the gain when the setting frequency of the tracking actuator 119 is set to be the frequency fw. A method for determining the setting frequency fw and the amplitude Hw will be described later. Next, in 5801, the micon 733 sets the setting frequency fw and the amplitude Hw determined in 5800 for the oscillation signal generation circuit 732 to put the oscillation signal generation circuit 732 into an operation state.

When image drawing is completed, the micon 733 stops the operation of the oscillation signal generation circuit 732 in S802.

Next, a method for determining the setting frequency fw and the amplitude Hw in S800 will be described.

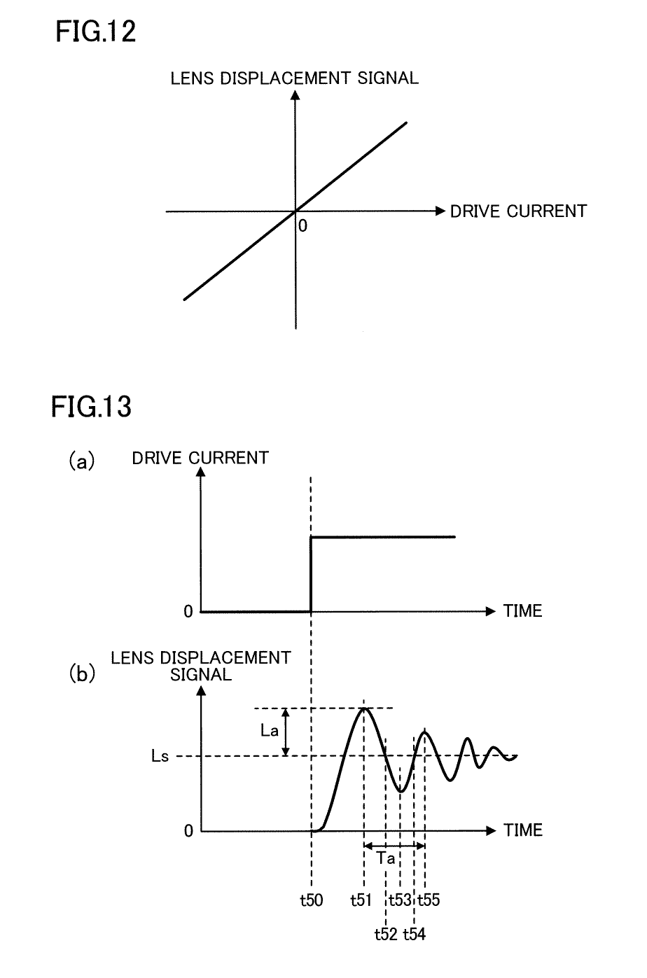

FIG. 12 shows the relationship of an output signal of a TE generation circuit 708 to the drive current for the tracking actuator 119 when the drawing area where a track is not formed is irradiated with the laser light 121. In this case, the output signal of the TE generation circuit 708 is a lens displacement signal indicating a displacement amount of the object lens 120 in the radial direction of the optical disc 101. The micon 733 stores the DC gain of the tracking actuator 119 in a memory provided therein in advance, and thus, can recognize, based on the lens displacement signal, by how many μm the object lens 120 has been displaced in the radial direction of the optical disc 101.

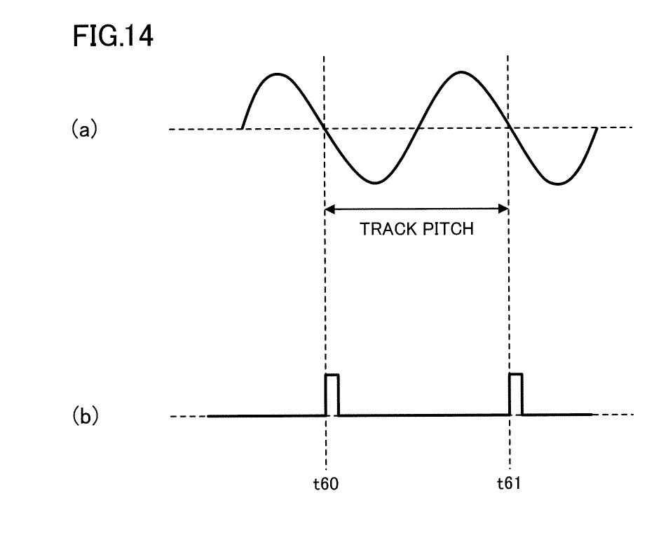

The operation of the micon 733 when the setting frequency fw and the amplitude Hw are determined will be described with reference to FIG. 13.

The micon 733 operates the step signal generation circuit 702 at t50. Thus, as shown in FIG. 13A, a drive current having a step waveform flows through the tracking actuator 119, the object lens 120 is displaced in the radial direction of the optical disc 101, and the lens displacement signal is changed in the manner shown in FIG. 13B. In FIG. 13B, Ls indicates the level of the lens displacement signal in a state where a response is settled. The lens displacement signal starts increasing at t50, reaches a maximal value at t51, becomes a local minimal value at t53, and becomes a local maximal value at t55. The inherent resonance frequency of the tracking actuator 119 is substantially equal to the reciprocal of time Ta from t51 to t55. Therefore, the micon 733 calculates the reciprocal of the time Ta. Also, the micon 733 can obtain the gain at the inherent resonance frequency based on the level of the lens displacement signal at t51 and the level Ls. This is because the relationship between Mp which is the amount of increase in gain at the inherent resonance frequency shown in FIG. 10 and Ls is determined according to transfer characteristics.

The micon 733 sets the setting frequency fw of the oscillation signal generation circuit 732 at 1/Ta and calculates and sets the amplitude Hw for causing predetermined displacement to occur based on the gain at the inherent resonance frequency.

The inherent resonance frequency of the tracking actuator 119 might change according to temperature change. Therefore, the micon 733 compares a temperature detected by the temperature sensor 701 to a temperature detected for the previous detection every predetermined time period, and if there is a temperature change equal to or greater than a predetermined value in the predetermined time period, the operation of S800 is performed, i.e., the setting frequency fw and the amplitude Hw are determined.

According to this embodiment, the gain of the tracking actuator 119 is higher than the DC gain. Thus, the tracking actuator 119 can displace the object lens 120 with a small drive current. Therefore, heat generation in the tracking actuator 119 can be reduced while the drive current is reduced, so that damage due to the heat generation in the tracking actuator 119 can be prevented without causing a problem of increase in cost for the optical head 704 and increase in size of the optical disc apparatus 700 in increasing heat resistance of the tracking direction displacement section.

Note that a configuration in which, when change in resonance frequency of the tracking actuator 119 according to temperature is small, the micon 733 does not perform the process of S800 and fixed values for the setting frequency fw and the amplitude Hw are recorded in a memory in the micon 733 in advance and are used may be employed.

In this embodiment, the micon 733 calculates the inherent resonance frequency and the gain of the tracking actuator 119 based on the lens displacement signal, and thus, serves as a displacement characteristic determination section. However, the inherent resonance frequency and the gain of the tracking actuator 119 may be calculated using a TE signal in a control data area of an inner circumference of the label surface in which a track is formed. When a push-pull method is used, the TE generation circuit 727 which calculates a TE signal based on a difference signal derived from outputs of a two-divided light detector and the micon 733 which calculates a resonance frequency using the TE signal form a displacement characteristic determination section which determines the resonance frequency as the setting frequency fw based on the difference signal derived from outputs of the two-divided light detector.

FIG. 14A shows an example of an output signal (TE signal) of the TE generation circuit 127 when the beam spot of the laser light 121 crosses a track. The horizontal axis indicates time and the vertical axis indicates the level of the TE signal. The TE signal is a sine wave, and a falling zero-crossing point corresponds to the center of a track. Note that a trench portion of the optical disc 101 serves as a track.

FIG. 14B shows a track crossing signal indicating that the beam spot has crossed the track.

As shown in FIG. 13B, at t51, t53, and t55, the moving speed of the beam spot is low, and thus, a time which it takes for the beam spot to move through 1 track pitch is long. That is, the cycle of the track crossing signal is long. In contrast, at t52 and t54, the moving speed of the beam spot is high, and thus, a time which it takes for the beam spot to move through 1 track pitch is shorter. That is, the cycle of the track crossing signal is shorter.

Therefore, t51, t52, t53, t54, and t55 can be specified based on change in cycle of the track crossing signal. Also, La in FIG. 13B can be obtained by counting rising edges of the track crossing signal in a period from t51 to t52.

When data in a track on the recording surface in which data is recorded is reproduced, the process of S800, i.e., the process of determining the setting frequency fw and the amplitude Hw and recording the setting frequency fw and the amplitude Hw in a memory of the micon 733 may be performed without using the TE signal in an area of the inner circumference of the label surface in which a track is formed in advance, and the recorded setting frequency fw and the amplitude Tw may be used when image drawing is performed.

In this embodiment, to obtain the inherent resonance frequency and the gain of the tracking actuator 119, the tracking actuator 119 is driven by a drive current having a step waveform. However, the tracking actuator 119 may be driven by setting the setting frequency of the oscillation signal generation circuit 732 to be different frequencies. For example, the micon (displacement characteristic determination section) 733 may be configured to drive the tracking actuator 119 while causing the amplitude of an output signal of the oscillation signal generation circuit 732 to be constant and changing the frequency. Then, a frequency at which the amplitude of the lens displacement signal is maximal may be determined as the setting frequency fw. Note that when the setting frequency fw is obtained in the above-described manner, the gain is calculated based on the ratio between the amplitude of an output signal of the oscillation signal generation circuit 732 and the amplitude of the lens displacement signal. Also, in this case, the displacement amount of the object lens 120 may be obtained using the track crossing signal based on the TE signal in an area in which a track is formed, and the obtained displacement amount may be used, instead of the lens displacement signal. In this case, the moving speed of the beam spot is the lowest and the cycle of the track crossing signal is maximal at a point where the displacement of the object lens 120 is maximal. Note that when the push-pull method is used, the TE generation circuit 727 which calculates the TE signal based on a difference signal derived from outputs of the two-divided light detector and the micon 733 which calculates the setting frequency fw using the TE signal form a displacement characteristic determination section which determines the setting frequency fw based on the difference signal derived from outputs of the two-divided light detector.

In this embodiment, the oscillation signal generation circuit 732 generates a sine wave, but the oscillation signal generation circuit 732 may be configured to generate a triangle wave, instead of a sine wave. This is because, when the frequency increases, the gain of the tracking actuator 119 is reduced at a frequency equal to f0 and at frequencies higher than f0.

In this embodiment, the setting frequency of the oscillation signal generation circuit 732 is set to be the inherent resonance frequency of the tracking actuator 119. However, when a frequency within a range with which the gain of the tracking actuator 119 is higher than the DC gain, similar advantages can be achieved.

The present invention is not limited to the embodiments described above, but various modifications are possible. It is without mentioning that such modifications should also be included in the scope of the invention.

An optical disc apparatus and an integrated circuit according to the present disclosure are useful as an optical disc apparatus which performs image drawing of a visible image by irradiating an optical disc including a discoloration layer which is discolored by heat or light with laser light, and an integrated circuit provided in the optical disc apparatus.

What is claimed is:

1. An integrated circuit which is provided in an optical disc apparatus for drawing a visible image on an optical disc including a discoloration layer which is discolored by heat or light,
the optical disc apparatus including a focusing section configured to focus laser light to irradiate the discoloration layer of the optical disc with the laser light, and a focus direction displacement section configured to displace the focusing section in a perpendicular direction to the discoloration layer of the optical disc by an amount corresponding to a drive signal, and
being configured so that, each time the optical disc is rotated a predetermined number of times with the discoloration layer irradiated with the laser light, a laser light irradiation position which is irradiated with the laser light is moved in a radial direction of the optical disc by a predetermined moving amount to draw a visible image,
the integrated circuit comprising:
a focus control section configured to perform focus control to generate a drive signal for the focus direction displacement section based on a focus error signal;
a focus control error determination section configured to determine whether there is a focus control error or not; and
a memory section configured to store error-time control signals which are used when there is a focus control error and correspond to a plurality of rotation angles,
wherein
the focus control section stops the focus control and generates the drive signal for the focus direction displacement section, according to a rotation angle, based on the error-time control signals stored in the memory section at a radial position where it is determined by the focus control error determination section that there is a focus control error.

2. The integrated circuit of claim 1, wherein
the focus control error determination section determines whether there is a focus control error or not based on whether an amount of reflected light of the laser light which is reflected from the optical disc is lower than a predetermined level or not.

3. The integrated circuit of claim 1, wherein
the focus control error determination section determines whether there is a focus control error or not based on whether an absolute value of the drive signal generated by the focus control of the focus control section is higher than a predetermined level or not.

4. The integrated circuit of claim 1, further comprising:
a laser power control section configured to cause laser power of the laser light to be higher when the focus control section stops the focus control and generates the drive signal for the focus direction displacement section based on the error-time control signals stored in the memory section than when the focus control is performed.

5. The integrated circuit of claim 1, further comprising:
a rotation number control section configured to cause the predetermined rotation number to be greater when the focus control section stops the focus control and generates the drive signal for the focus direction displacement section based on the error-time control signals stored in the memory section than when the focus control is performed.

6. The integrated circuit of claim 1, further comprising:
a moving amount control section configured to cause the predetermined moving amount to be smaller when the focus control section stops the focus control and generates the drive signal for the focus direction displacement section based on the error-time control signals stored in the memory section than when the focus control is performed.

7. An optical disc apparatus, comprising:
the integrated circuit of claim 1.

8. An integrated circuit which is provided in an optical disc apparatus for irradiating an optical disc including a discoloration layer which is discolored by heat or light with laser light to draw a visible image thereon, the optical disc apparatus including a focusing section configured to focus the laser light to irradiate the discoloration layer with the laser light, and a tracking direction displacement section configured to displace the focusing section in a radial direction of the optical disc according to a drive current at a setting frequency and having a second-order transfer characteristic,
the integrated circuit comprising:
a setting section configured to set the setting frequency to be a frequency within a range with which a gain of the tracking direction displacement section is higher than a DC gain while the visible image is drawn.

9. The integrated circuit of claim 8, further comprising:
a displacement characteristic determination section configured to calculate an amount of displacement of the focusing section, which corresponds to each of the frequencies when the tracking direction displacement section is driven with the setting frequency set to be a plurality of types of frequencies, based on a track crossing signal indicating a tracking crossing timing of a spot of the laser light with which the focusing section has irradiated the discoloration layer, and determines, based on the amount of displacement of the focusing section which corresponds to each of the frequencies, the setting frequency while the visible image is drawn.

10. The integrated circuit of claim 8, wherein
a displacement characteristic determination section configured to calculate, based on a difference signal derived from outputs of a two-divided light detector which receives reflected light of the laser light with which the focusing section has irradiated the discoloration layer from the optical disc, an amount of displacement of the focusing section, which corresponds to each of the frequencies when the tracking direction displacement section is driven with the setting frequency set to be a plurality of types of frequencies, and determines, based on the amount of displacement of the focusing section which corresponds to each of the frequencies, the setting frequency while the visible image is drawn.

11. The integrated circuit of claim 8, further comprising:
a displacement characteristic determination section configured to calculate, based on a track crossing signal indicating a tracking crossing timing of a spot of the laser light with which the focusing section has irradiated the discoloration layer, an amount of the displacement of the focusing section when the tracking direction displacement section is driven by a drive current having a step waveform, and determine, based on the calculated amount of displacement of the focusing section, the setting frequency while the visible image is drawn.

12. The integrated circuit of claim 8, further comprising:
a displacement characteristic determination section configured to calculate, based on a difference signal derived from outputs of a two-divided light detector which receives reflected light of the laser light with which the focusing section has irradiated the discoloration layer from the optical disc, an amount of the displacement of the focusing section when the tracking direction displacement section is driven by a drive current having a step waveform, and determine, based on the calculated amount of displacement of the focusing section, the setting frequency while the visible image is drawn.

13. The integrated circuit of claim 9, wherein
the optical disc apparatus includes a temperature sensor configured to detect a temperature of the tracking direction displacement section, and
when the temperature detected by the temperature sensor is changed by an amount equal to or larger than a predetermined value in a predetermined time, determination of the setting frequency by the displacement characteristic determination section and setting of the setting frequency by the setting section are performed.

14. An optical disc apparatus, comprising:
the integrated circuit of claim 8.
